(19) United States
(12) Patent Application Publication
(10) Pub. No.: US 2024/0329510 A1
(43) Pub. Date: Oct. 3, 2024

(54) OPTICAL SYSTEM, MULTI-BEAM PROJECTION OPTICAL SYSTEM, MULTI-BEAM PROJECTION APPARATUS, IMAGE PROJECTION APPARATUS, AND IMAGING APPARATUS

(71) Applicant: Panasonic Intellectual Property Management Co., Ltd., Osaka (JP)

(72) Inventor: Takuya IMAOKA, Kanagawa (JP)

(21) Appl. No.: 18/735,477

(22) Filed: Jun. 6, 2024

Related U.S. Application Data
(63) Continuation of application No. PCT/JP2022/026316, filed on Jun. 30, 2022.

(30) Foreign Application Priority Data
Dec. 17, 2021 (JP) 2021-205229

(51) Int. Cl. G03B 21/28; G02B 5/04

(52) U.S. Cl. CPC G03B 21/28; G02B 5/04

(57) ABSTRACT

The present disclosure is directed to an optical system having a reduction conjugate point on a reduction side and a magnification conjugate point on a magnification side that are optically conjugate with each other, and includes a prism including a first transmission surface located on the reduction side, a second transmission surface located on the magnification side, and at least three reflection surfaces located on an optical path therebetween, wherein in the meridional plane, two light rays traveling in a direction perpendicular to the first rectangular region from two points on the first rectangular region intersect at two intersection positions after passing through the first transmission surface and then reflected by the at least three reflection surfaces and before passing through the second transmission surface, and the number of reflection of the two light rays intersecting at each intersection position before reaching the respective intersection positions is the same.

### CROSS-REFERENCE TO RELATED APPLICATIONS

This application is a continuation of International Patent Application No. PCT/JP2022/026316, filed on Jun. 30, 2022, which claims the benefit of Japanese Patent Application No. 2021-205229, filed on Dec. 17, 2021, the contents all of which are incorporated herein by reference.

### TECHNICAL FIELD

The present disclosure relates to an optical system using a prism. The present disclosure also relates to a multi-beam projection optical system and a multi-beam projection apparatus using such an optical system. The present disclosure also relates to an image projection apparatus and an imaging apparatus using such an optical system.

### BACKGROUND ART

Patent Document 1 discloses an image-formation optical system including a prism integrally provided with an incident surface, reflection surfaces and an emitting surface.

### PRIOR ART

[Patent Document 1] JP 2000-231060 A

The present disclosure provides an optical system that can be manufactured with a small number of parts, wherein the effective range from the optical axis to the peripheral rays can be reduced, and the size and height thereof can be reduced. The present disclosure also provides a multi-beam projection optical system and a multi-beam projection apparatus using such an optical system. The present disclosure also provides an image projection apparatus and an imaging apparatus using such an optical system.

An aspect of the present disclosure is directed to an optical system having a reduction conjugate point on a reduction side and a magnification conjugate point on a magnification side that are optically conjugate with each other, and includes

a prism including a first transmission surface located on the reduction side, a second transmission surface located on the magnification side, and at least three reflection surfaces located on an optical path between the first transmission surface and the second transmission surface,

wherein the prism has a meridional plane through which a light ray reflected by the at least three reflection surfaces pass,

wherein a first rectangular region at the reduction conjugate point and a second rectangular region at the magnification conjugate point have an optically conjugate image forming relation, and

wherein in the meridional plane, two light rays traveling in a direction perpendicular to the first rectangular region from two points on the first rectangular region intersect at two intersection positions after passing through the first transmission surface and then reflected by the at least three reflection surfaces and before passing through the second transmission surface, and the number of reflection of the two light rays intersecting at each intersection position before reaching the respective intersection positions is the same.

Further, a multi-beam projection optical system according to another aspect of the present disclosure, includes: the above-described the optical system; and a diffractive optical element that spatially branches the light ray emitted from the prism.

Further, a multi-beam projection apparatus according to another aspect of the present disclosure includes: the above-described multi-beam projection optical system; and a light source that generates one or more light beams toward the multi-beam projection optical system.

Still further, an image projection apparatus according to another aspect of the present disclosure includes the above-described optical system and an image forming element that generates an image to be projected through the optical system onto a screen.

Still further, an imaging apparatus according to another aspect of the present disclosure includes the above-described optical system and an imaging element that receives an optical image formed by the optical system to convert the optical image into an electrical image signal.

According to the optical system according to the present disclosure, it can be manufactured with a small number of parts, the effective range from the optical axis to the peripheral rays can be reduced, and the size and height thereof can be reduced.

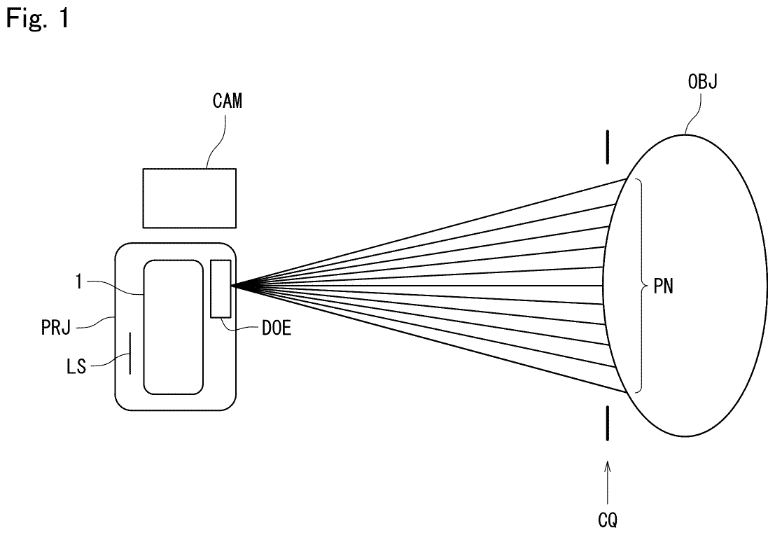

FIG. 1 is an overall configuration diagram illustrating an example of a multi-beam projection apparatus according to the present disclosure.

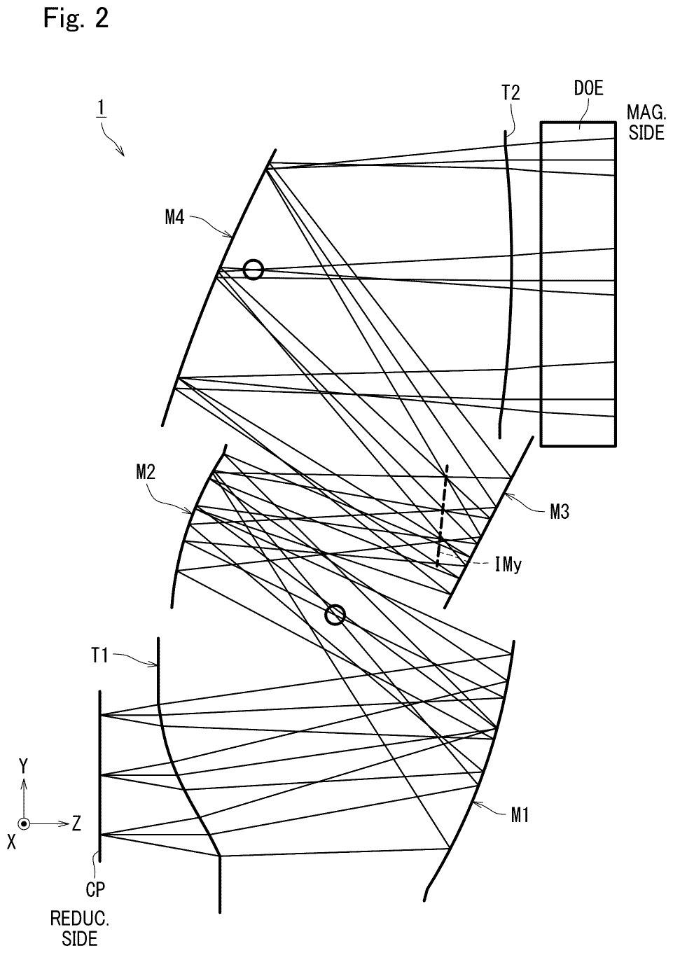

FIG. 2 is a layout diagram illustrating an optical system according to Example 1.

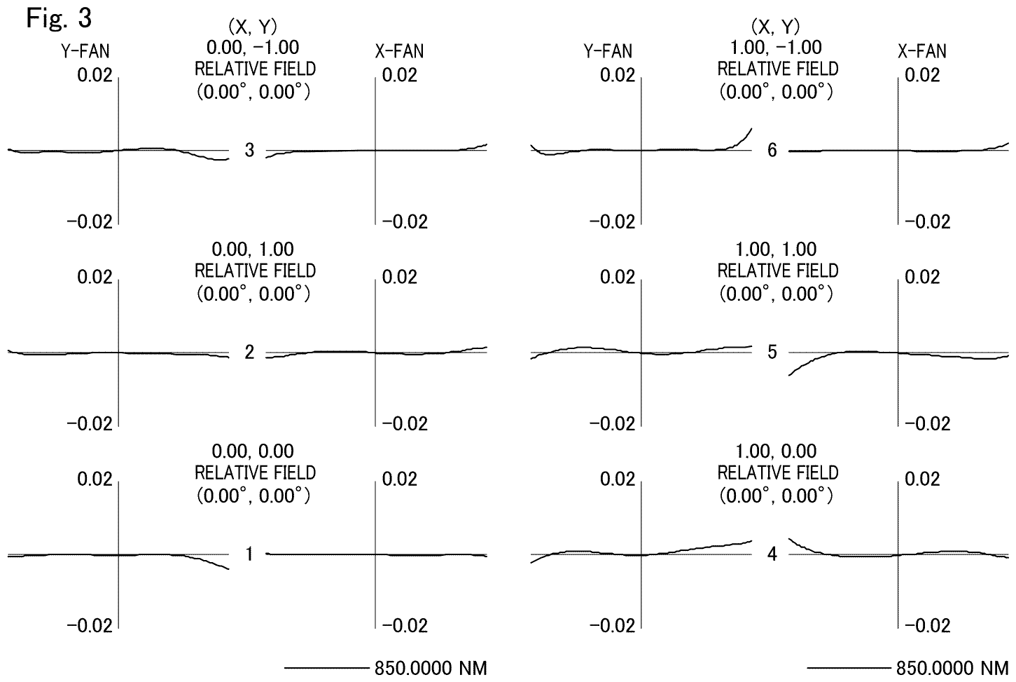

FIG. 3 is a diagram illustrating lateral aberration of the optical system according to Example 1.

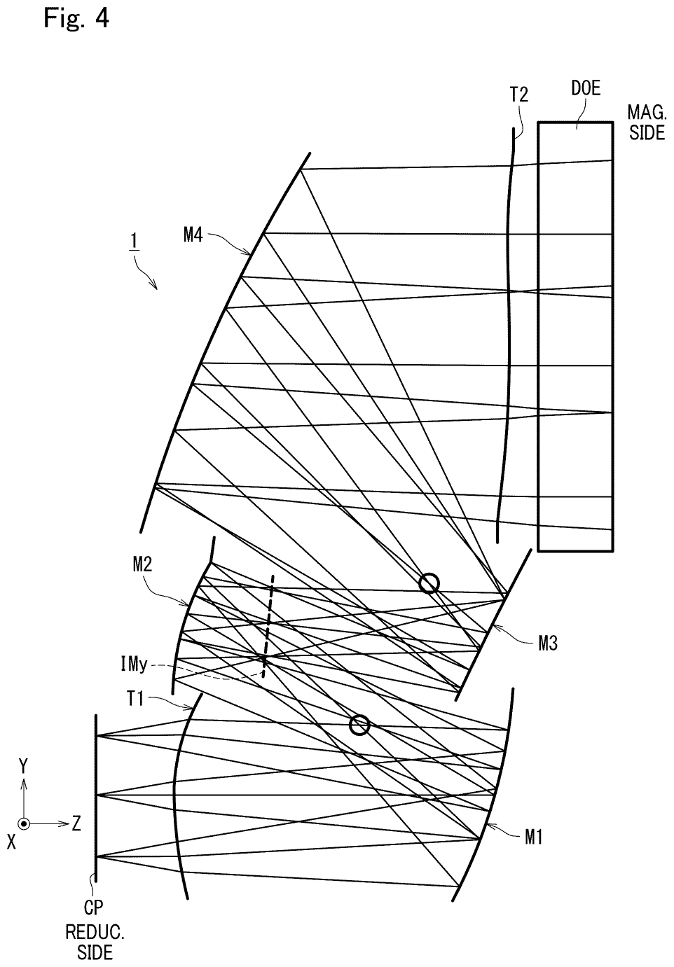

FIG. 4 is a layout diagram illustrating an optical system according to Example 2.

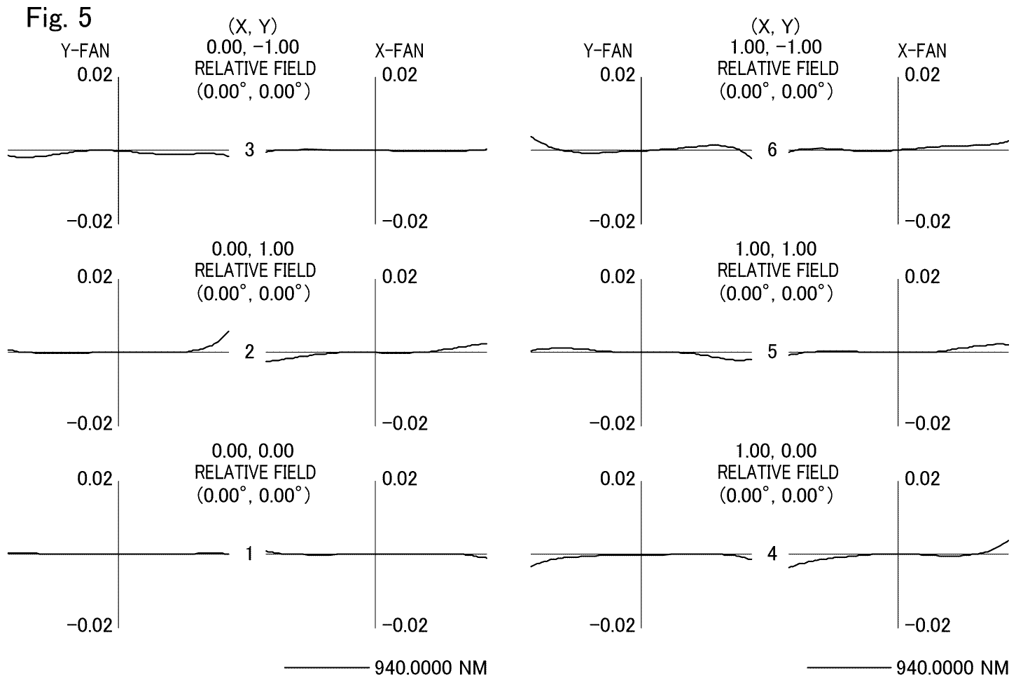

FIG. 5 is a diagram illustrating lateral aberration of the optical system according to Example 2.

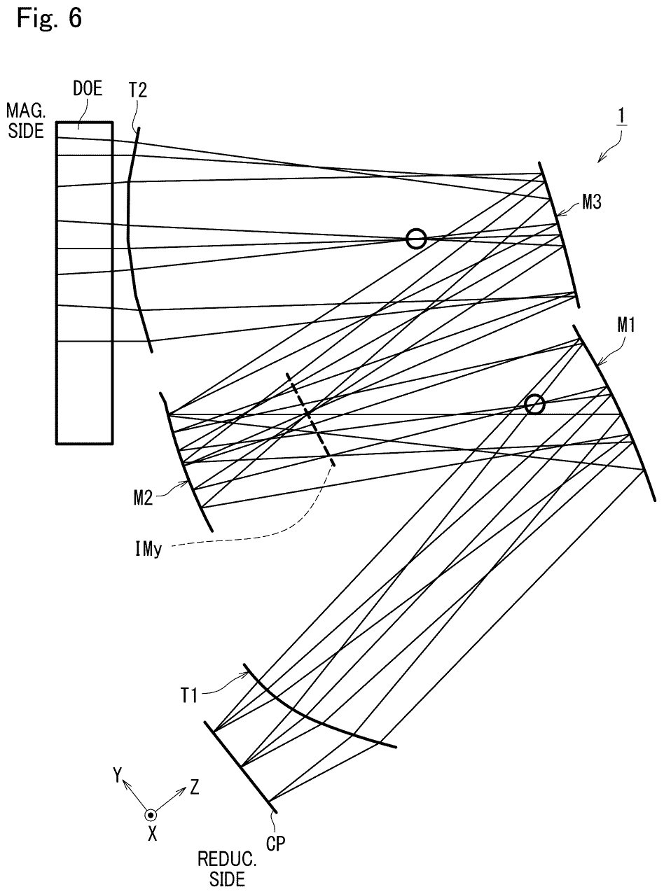

FIG. 6 is a layout diagram illustrating an optical system according to Example 3.

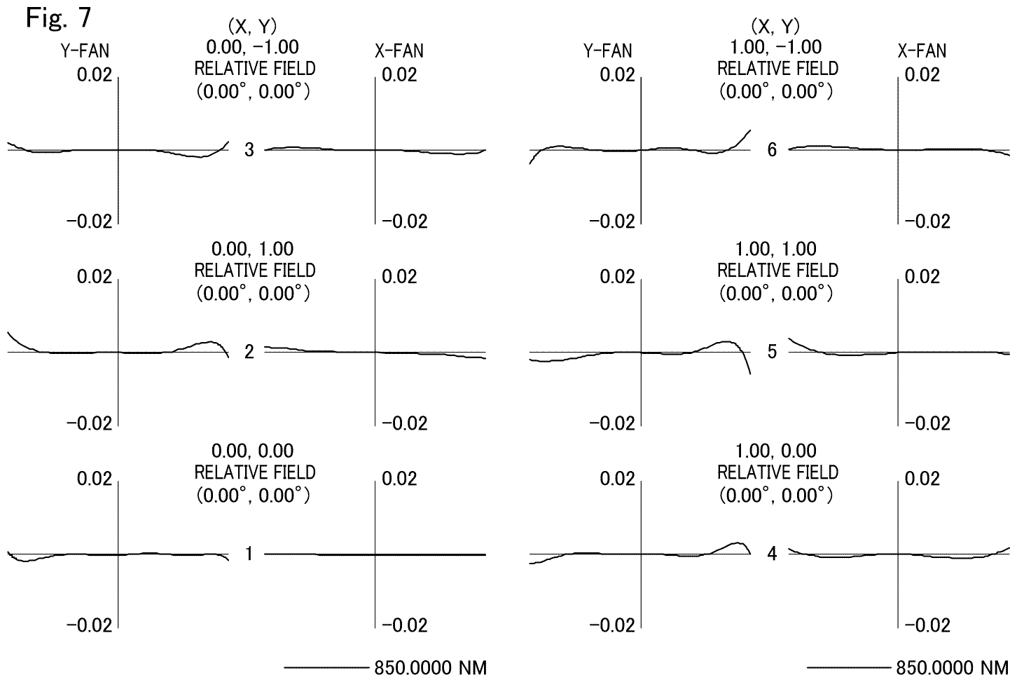

FIG. 7 is a diagram illustrating lateral aberration of the optical system according to Example 3.

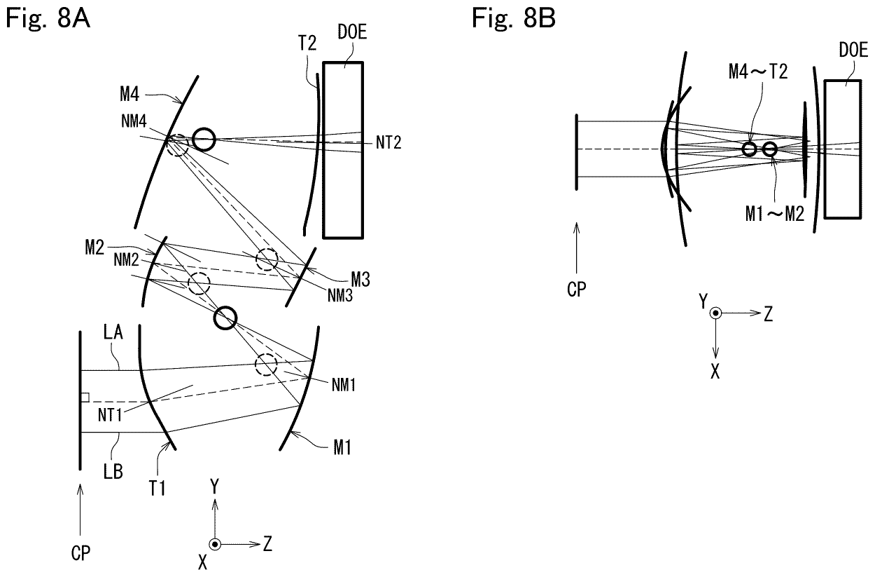

FIG. 8A is an YZ cross-sectional view taken along a meridional plane showing intersection positions of two light rays LA and LB.

FIG. 8B is an XZ cross-sectional view taken along a plane perpendicular to the meridional plane.

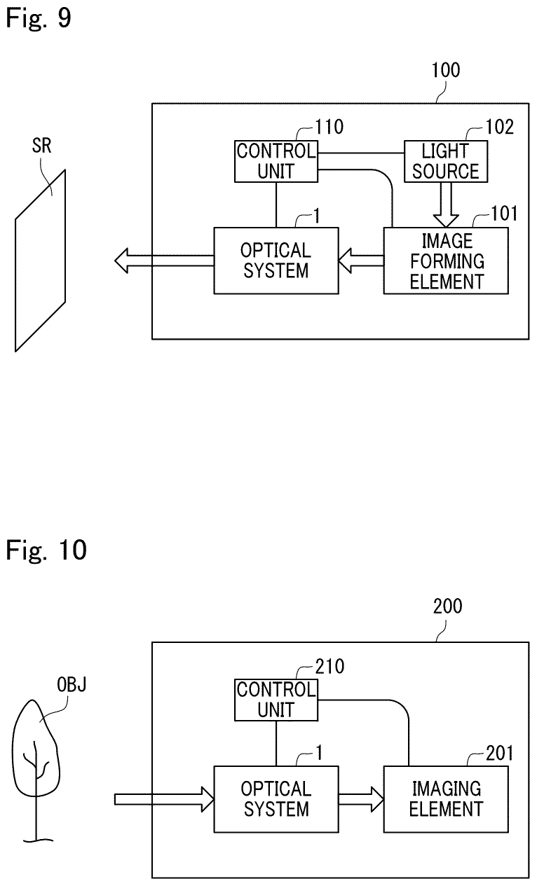

FIG. 9 is a block diagram showing an example of the image projection apparatus according to the present disclosure.

FIG. 10 is a block diagram showing an example of the imaging apparatus according to the present disclosure.

### DETAILED DESCRIPTION

Hereinafter, embodiments are described in detail with reference to the drawings as appropriate. However, unnecessarily detailed descriptions may be omitted. For example, detailed descriptions of well-known items or redundant descriptions of substantially the same configurations may be omitted. This is to prevent the following description from being unnecessarily redundant and to facilitate understanding by those skilled in the art.

It should be noted that the applicant provides the accompanying drawings and the following description for those skilled in the art to fully understand the present disclosure, and it is not intended to limit the subject matter described in the claims thereby.

Each example of an optical system according to the present disclosure is described below. In each example, described is an example in which the optical system is used in a projector (an example of an image projection apparatus) that projects onto a screen image light of an original image obtained by spatially modulating incident light using an image forming element, such as liquid crystal or digital micromirror device (DMD), based on an image signal. In other words, the optical system according to the present disclosure can be used for magnifying the original image on the image forming element arranged on the reduction side to project the image onto the screen (not shown), which is arranged on an extension line on the magnification side. However, a projection surface is not limited to the screen. Examples of the projection surface includes walls, ceilings, floors, windows, etc. in houses, stores, or vehicles and airplanes used as means for transportation.

Further, the optical system according to the present disclosure can also be used for collecting light emitted from an object located on the extension line on the magnification side to form an optical image of the object on an imaging surface of an imaging element arranged on the reduction side.

Furthermore, the optical system according to the present disclosure can also be used in a multi-beam projection apparatus that irradiates a plurality of light beams toward an object having a three-dimensional (3D) shape. The three-dimensional position of the light spot focused on the object may be detected by a stereo camera and may be utilized as three-dimensional information of the object.

### First Embodiment

FIG. 1 is an overall configuration diagram illustrating an example of a multi-beam projection apparatus according to the present disclosure. A multi-beam projection apparatus PRJ includes a light source LS, an optical system 1, a diffractive optical element DOE, and the like. The light source LS is a multi-beam light source that can generate a plurality of light beams, and for example, a vertical cavity surface emitting laser (VCSEL) array, an LED array, an OLED array, or the like can be used.

The optical system 1 includes a prism having at least one light transmission surface and at least one light reflection surface, which can condense the light beams from the light source LS onto the surface of an object OBJ. An magnification conjugate point CQ of the optical system 1 is set on the surface of the object OBJ. The diffractive optical element DOE spatially branches the light beams emitted from the prism into a plurality of light beams, and further increases the number of light spots to be formed on the surface of the object OBJ. The irradiation pattern to the object OBJ may be a regularly arranged pattern, for example, a matrix pattern or a triangular lattice pattern, or may be a randomly arranged pattern.

A stereo camera CAM is installed in the vicinity of the multi-beam projection apparatus PRJ in order to capture an image of light spots formed on the surface of the object OBJ and then convert the image into image data. The obtained image data is subjected to image processing using a computer and converted into three-dimensional (3D) information of the object OBJ.

The diffractive optical element DOE has a role of improving the 3D measurement accuracy by increasing the number of light spots. When the light beams from the light source LS can be directly used for measurement, the diffractive optical element DOE can be omitted.

### Second Embodiment

An optical system according to a second embodiment of the present disclosure will be described below with reference to FIGS. 2 to 7.

### Example 1 and Example 2

FIG. 2 is a layout diagram illustrating an optical system 1 according to Example 1. FIG. 4 is a layout diagram illustrating an optical system 1 according to Example 2. The optical system 1 has a reduction conjugate point CP (surface number S1) on the reduction side located on the left side in the drawing and a magnification conjugate point (CQ in FIG. 1) on the magnification side located on the right side in the drawing. The optical system 1 includes a prism formed of a transparent medium. Note that, for the surface number S1 and the like, reference is made to later-described numerical examples.

An image region at the reduction conjugate point CP is defined as a first rectangular region having a longitudinal direction (X-direction) and a lateral direction (Y-direction). In addition, an image region at the magnification conjugate point CQ is also defined as a second rectangular region having the longitudinal direction and the lateral direction. The first rectangular region and the second rectangular region have an optically conjugate image forming relation. A principal ray travels along the normal direction (Z-direction) of the first rectangular region. As an example, the first rectangular region may have an aspect ratio of 3:2, 4:3, 16:9, 16:10, 256:135, or the like, and either corresponds to an image display region of an image forming element in a case of an image projection apparatus, or corresponds to an imaging region of an imaging element in a case of an imaging apparatus, or corresponds to a light emitting surface of a light source in a case of a multi-beam projection apparatus.

In addition, an intermediate imaging position that is conjugate with each of the reduction conjugate point CP and the magnification conjugate point CQ is located inside the optical system 1. This intermediate imaging position is illustrated as a Y-direction intermediate image IMy in FIGS. 2 and 4, but an X-direction intermediate image IMx is not illustrated.

The prism can be formed of a transparent medium, for example, glass, synthetic resin, or the like. The prism has a first transmission surface T1 located on the reduction side, a second transmission surface T2 located on the magnification side, and four reflection surfaces, i.e., a first reflection surface M1, a second reflection surface M2, a third reflection surface M3, and a fourth reflection surface M4 that are located on the optical path between the first transmission surface T1 and the second transmission surface T2. The first transmission surface T1 has a free-form surface shape with a convex surface facing the reduction side (S2). The first reflection surface M1 has a free-form surface shape with a concave surface facing a direction in which a light ray made incident on the first reflection surface M1 is reflected (S4). The second reflection surface M2 has a free-form surface shape with a concave surface facing a direction in which a light ray made incident on the second reflection surface M2 is reflected (S8). The third reflection surface M3 has a free-form surface shape with a convex surface facing a direction in which a light ray made incident on the third reflection surface M3 is reflected (S12). The fourth reflection surface M4 has a free-form surface shape with a concave surface facing a direction in which a light ray made incident on the fourth reflection surface M4 is reflected (S16). The second transmission surface T2 has a free-form surface shape with a convex surface facing the magnification side (S19).

The diffractive optical element DOE is an optical element made of parallel plate glass having a first surface (S20) and a second surface (S21), in which a fine structure having a pitch less than a wavelength order of light is formed on a surface or inside thereof. As a result, a multi-beam projection optical system that spatially splits light made incident on the diffractive optical element DOE to generate multiple beams is obtained.

In the meridional plane (YZ-plane), the light rays reflected by the reflection surfaces M1 to M4 pass through. In the present embodiment, two light rays traveling in a direction perpendicular to the first rectangular region from two points on the first rectangular region of the reduction conjugate point CP intersect at two intersection positions (indicated by a solid circle) after passing through the first transmission surface T1 and then reflected by the reflection surfaces M1 to M4 and before passing through the second transmission surface T2. Furthermore, the number of reflection of two light rays intersecting at each intersection position before reaching the intersection position is the same. Since the two intersection positions exist inside the prism in this way, the size of the reflection surface can be reduced, and the size and height of the entire prism can be reduced. Details will be described later.

FIG. 3 is a diagram illustrating lateral aberration of the optical system 1 according to Example 1. FIG. 5 is a diagram illustrating lateral aberration of the optical system 1 according to Example 2. Each graph corresponds to normalized coordinates (X, Y)=(0, 0), (0, 1), (0, −1), (1, 0), (1, 1), and (1, −1) of a first rectangular region at the reduction conjugate point. The wavelength of light in the example 1 is 850.0 nm. The wavelength of light in Example 2 is 940.0 nm. From these graphs, it is found that a clear light spot is obtained in the second rectangular region (for example, an object surface, a screen), and excellent optical performance is exhibited.

### Example 3

FIG. 6 is a layout diagram illustrating an optical system 1 according to Example 3. The optical system 1 has a reduction conjugate point CP (surface number S1) on the reduction side located on the left side in the drawing and a magnification conjugate point (CQ in FIG. 1) on the magnification side located on the right side in the drawing. The optical system 1 includes a prism formed of a transparent medium. Note that, for the surface number S1 and the like, reference is made to later-described numerical examples. The optical system 1 has the same configuration as that of Example 1, but hereinafter, the description overlapping with that of Example 1 may be omitted.

In addition, an intermediate imaging position that is conjugate with each of the reduction conjugate point CP and the magnification conjugate point CQ is located inside the optical system 1. This intermediate imaging position is illustrated as the Y-direction intermediate image IMy in FIG. 6, but the X-direction intermediate image IMx is not illustrated.

The prism can be formed of a transparent medium, for example, glass, synthetic resin, or the like. The prism has a first transmission surface T1 located on the reduction side, a second transmission surface T2 located on the magnification side, and three reflection surfaces, i.e., a first reflection surface M1, a second reflection surface M2, and a third reflection surface M3 that are located on the optical path between the first transmission surface T1 and the second transmission surface T2. The first transmission surface T1 has a free-form surface shape with a concave surface facing the reduction side (S2). The first reflection surface M1 has a free-form surface shape with a concave surface facing a direction in which a light ray made incident on the first reflection surface M1 is reflected (S4). The second reflection surface M2 has a free-form surface shape with a concave surface facing a direction in which a light ray made incident on the second reflection surface M2 is reflected (S8). The third reflection surface M3 has a free-form surface shape with a concave surface facing a direction in which a light ray made incident on the third reflection surface M3 is reflected (S12). The second transmission surface T2 has a free-form surface shape with a convex surface facing the magnification side (S15).

The diffractive optical element DOE is an optical element made of parallel plate glass having a first surface (S16) and a second surface (S17), and a fine structure having a pitch less than a wavelength order of light is formed on a surface or inside thereof. As a result, a multi-beam projection optical system that spatially splits light made incident on the diffractive optical element DOE to generate multiple beams is obtained.

In the meridional plane (YZ-plane), the light rays reflected by the reflection surfaces M1 to M3 pass through. In the present embodiment, two light rays traveling in a direction perpendicular to the first rectangular region from two points on the first rectangular region of the reduction conjugate point CP intersect at two intersection positions (indicated by a solid circle) after passing through the first transmission surface T1 and then reflected by the reflection surfaces M1 to M3 and before passing through the second transmission surface T2. Furthermore, the number of reflection of two light rays intersecting at each intersection position before reaching the intersection position is the same. Since the two intersection positions exist inside the prism in this way, the size of the reflection surface can be reduced, and the size and height of the entire prism can be reduced. Details will be described later.

FIG. 7 is a diagram illustrating lateral aberration of the optical system 1 according to Example 3. Normalized coordinates and wavelengths of each graph are similar to those in Example 1. From these graphs, it is found that a clear light spot is obtained in the second rectangular region (for example, an object surface, a screen), and excellent optical performance is exhibited.

In the optical system 1 according to Examples 1 to 3, since the prism integrates the first transmission surface T1, the second transmission surface T2, the first to fourth reflection surfaces M1 to M4 (Examples 1 to 2), or the first to third reflection surfaces M1 to M3 (Example 3), assembly adjustment between optical components can be reduced, and manufacturing cost can be suppressed. In addition, the optical surface having an optical power of the prism does not have an axis that is rotationally symmetric, that is, the optical surface is formed as a free-form surface having different curvatures along the X-axis and the Y-axis perpendicular to the surface normal. By using a free-form surface capable of defining different curvatures along the X-axis and the Y-axis for the optical surface of the prism, the degree of freedom for correcting distortion satisfactorily increases, so that the optical system can be downsized.

Next, conditions that can be satisfied by the optical system according to the present embodiment will be described below. Note that although a plurality of conditions are defined for the optical system according to each of the embodiments, all of these plurality of conditions may be satisfied, or the individual conditions may be satisfied to obtain the corresponding effects.

The optical system according to the present embodiment is an optical system having a reduction conjugate point CP on a reduction side and a magnification conjugate point CQ on a magnification side that are optically conjugate with each other, and includes

a prism including a first transmission surface T1 located on the reduction side, a second transmission surface T2 located on the magnification side, and at least three reflection surfaces M1 to M4 located on an optical path between the first transmission surface T1 and the second transmission surface T2, wherein the prism has a meridional plane through which a light ray reflected by the at least three reflection surfaces M1 to M4 pass,

wherein a first rectangular region at the reduction conjugate point CP and a second rectangular region at the magnification conjugate point CQ have an optically conjugate image forming relation, and

wherein in the meridional plane, two light rays traveling in a direction perpendicular to the first rectangular region from two points on the first rectangular region intersect at two intersection positions after passing through the first transmission surface T1 and then reflected by the at least three reflection surfaces M1 to M4 and before passing through the second transmission surface T2, and the number of reflection of the two light rays intersecting at each intersection position before reaching the respective intersection positions is the same.

FIG. 8A is an YZ cross-sectional view taken along a meridional plane showing intersection positions of two light rays LA and LB, and FIG. 8B is an XZ cross-sectional view taken along a plane perpendicular to the meridional plane. A first rectangular region is set at the reduction conjugate point CP located on the left side of the drawing, and a second rectangular region is set at the magnification conjugate point (CQ in FIG. 1) located on the right side of the drawing. Here, for easy understanding, the Z-axis is set in a direction perpendicular to the first rectangular region, and the first rectangular region is parallel to the XY-plane including the X-axis (perpendicular to the sheet surface) and the Y-axis.

As illustrated in FIG. 8A, the two light rays LA and LB travel in the Z-direction from any two points on the first rectangular region. Subsequently, the light rays LA and LB pass through the first transmission surface T1, are then reflected by the first reflection surface M1, and then travel toward the next second reflection surface M2. At this time, the light rays LA and LB intersect with each other at a first intersection position (indicated by a solid circle).

Subsequently, the light rays LA and LB are reflected by the second reflection surface M2 and then travel toward the next third reflection surface M3. Subsequently, the light rays LA and LB are reflected by the third reflection surface M3 and then travel toward the next fourth reflection surface M4. Subsequently, the light rays LA and LB are reflected by the fourth reflection surface M4 and then travel toward the second transmission surface T2. At this time, the light rays LA and LB intersect with each other at a second intersection position (indicated by a solid circle). Subsequently, the light rays LA and LB pass through the second transmission surface T2 and are made incident on the diffractive optical element DOE.

Subsequently, one light ray of the light rays LA and LB is two-dimensionally branched into a plurality of light rays by the diffractive effect of the diffractive optical element DOE, and the surface (corresponding to the magnification conjugate point CQ) of the object OBJ is irradiated with the light rays as illustrated in FIG. 1.

The optical system according to the present embodiment is configured such that the two light rays LA and LB intersect at two intersection positions after passing through the first transmission surface T1 and then reflected by the first to fourth reflection surfaces M1 to M4 and before passing through the second transmission surface T2, and the number of reflection of the two light rays intersecting at each intersection position before reaching the respective intersection positions is the same.

With such a configuration, the two intersection positions can exist inside the prism, and the effective range from the optical axis to the peripheral light ray can be reduced. In addition, the size of the reflection surface can be reduced, and the size and height of the entire prism can be reduced.

Here, the meaning of “the number of reflection of two light rays intersecting at each intersection position before reaching the respective intersection positions is the same” will be described in detail. At the first intersection position (solid circle), the light rays LA and LB are reflected by the first reflection surface M1, therefore the number of reflection is one. Next, at the second intersection position (solid circle), the light rays LA and LB are reflected by the first to fourth reflection surfaces M1 to M4, therefore the number of reflection is four.

On the other hand, as illustrated in FIG. 8A, at a first pseudo intersection position (indicated by a dash line circle), the light ray LA does not reach the first reflection surface M1, and thus the number of reflection is zero, whereas the light ray LB is reflected by the first reflection surface M1, and thus the number of reflection is one. At the next pseudo intersection position (indicated by a dash line circle), the light ray LA is reflected by the first to second reflection surfaces M1 and M2, and thus the number of reflection is two, whereas the light ray LB is reflected by the first reflection surface M1, and thus the number of reflection is one. At the next pseudo intersection position (indicated by a dash line circle), the light ray LA is reflected by the first to third reflection surfaces M1 to M3, and thus the number of reflection is three, whereas the light ray LB is reflected by the first to second reflection surfaces M1 and M2, and thus the number of reflection is two. At the next pseudo intersection position (indicated by a dash line circle), the light beam LA is reflected by the first to third reflection surfaces M1 to M3, and thus the number of reflection is three, whereas the light ray LB is reflected by the first to fourth reflection surfaces M1 to M4, and thus the number of reflection is four. Thus, the pseudo intersection positions at which the numbers of reflection of the light rays LA and LB are different are excluded from the intersection positions according to the present disclosure.

In the optical system according to the present embodiment, an intermediate imaging position IMy having a conjugate relation with each of the reduction conjugate point CP and the magnification conjugate point CQ may be positioned inside the prism.

According to such a configuration, the effective range from the optical axis to the peripheral light ray is reduced, and the size and height of the entire prism can be reduced. In addition, one-side defocus (partial defocus), astigmatism, and field curvature can be reduced.

In the optical system according to the present embodiment, the prism includes at least the first transmission surface T1, a first reflection surface M1, a second reflection surface M2, and the second transmission surface T2 in this order from the reduction side to the magnification side, and one of the two intersection positions may be positioned between the first reflection surface M1 and the second reflection surface M2.

According to such a configuration, the effective range from the optical axis to the peripheral light beam can be reduced. In addition, one-side defocus, astigmatism, and field curvature can be reduced.

The optical system according to the present embodiment may satisfy the following Expression (1):

$$1. < \vert ET / ED \vert < 5. \qquad ( 1 )$$

where ET is a distance from the second transmission surface T2 to a pupil position on the magnification side, and ED is a pupil diameter on the magnification side.

In the present embodiment, the effective range from the optical axis to the peripheral light beam can be reduced by focusing on the specific parameter (ET, ED) and satisfying Expression (1) expressing the relation between these parameters, and the size and height of the entire prism can be reduced. If exceeding the upper limit value of Expression (1), the effective diameter of the surface on the magnification side will increase. If falling below the lower limit value of Expression (1), the effective diameter on the reduction side will increase.

The optical system according to the present embodiment may satisfy the following Expression (1a):

$$2. < \vert ET / ED \vert < 4. . \qquad ( 1 a )$$

The optical system according to the present embodiment may satisfy the following Expression (2):

$$- 10 \text{.0} < ( rt 1 y \times rt 2 x ) / ( rt 1 x \times rt 2 y ) < 10. \qquad ( 2 )$$

where rt1x is an x-direction partial curvature at a position where a light ray traveling in the z-direction from the center of the first rectangular region passes through the first transmission surface T1, rt1y is a y-direction partial curvature at a position where a light ray traveling in the z-direction from the center of the first rectangular region passes through the first transmission surface T1, rt2x is an x-direction partial curvature at a position where a light ray traveling in the z-direction from the center of the first rectangular region passes through the second transmission surface T2, rt2y is a y-direction partial curvature at a position where a light ray traveling in the z-direction from the center of the first rectangular region passes through the second transmission surface T2, the x-direction is a direction perpendicular to the meridional plane, the y-direction is a direction parallel to an intersection line between the meridional plane and the first rectangular region, and the z-direction is a direction perpendicular to the first rectangular region.

In the present embodiment, the astigmatism can be reduced by focusing on specific parameters (rt1x, rt1y, rt2x, rt2y) and satisfying Expression (2) expressing the relation among these parameters. If exceeding the upper limit value of Expression (2) or falling below the lower limit value of Expression (2), the astigmatism will increase.

Here, the partial curvature radius at an arbitrary point on the free-form surface of the prism can be mathematically calculated using the first derivative and the second derivative of the function representing the free-form surface. When the function representing the free-form surface is unknown, the partial radius of curvature can be defined by the radius of a circle passing through the point on the free-form surface, an upper point on the free-form surface separated from the point by the distance of +0.001 mm to +0.100 mm in a direction perpendicular to the optical axis, and a lower point on the free-form surface separated from the point by the distance of −0.001 mm to −0.100 mm in a direction perpendicular to the optical axis.

The optical system according to the present embodiment may satisfy the following Expression (2a):

$$0. < ( rt 1 y \times rt 2 x ) / ( rt 1 x \times rt 2 y ) < 5. . \qquad ( 2 a )$$

The optical system according to the present embodiment may satisfy the following Expression (3):

$$0.5 < rm 1 x / rm 1 y < 4. \qquad ( 3 )$$

where rm1x is an x-direction partial curvature at a position where a light ray traveling in the z-direction from the center of the first rectangular region passes through the first reflection surface M1, rm1y is a y-direction partial curvature at a position where a light ray traveling in the z-direction from the center of the first rectangular region passes through the first reflection surface M1, the x-direction is a direction perpendicular to the meridional plane, the y-direction is a direction parallel to an intersection line between the meridional plane and the first rectangular region, and the z-direction is a direction perpendicular to the first rectangular region.

In the present embodiment, the astigmatism can be reduced and the size of the prism can be reduced by focusing on specific parameters (rm1x, rm1y) and satisfying Expression (3) expressing the relation between these parameters. If exceeding the upper limit value of Expression (3), the astigmatism will increase. If falling below the lower limit value of Expression (3), the size of the prism will increase.

The optical system according to the present embodiment may satisfy the following Expression (3a):

$$0.8 < rm 1 x / rm 1 y < 3. . \qquad ( 3 a )$$

The optical system according to the present embodiment may satisfy the following Expression (4):

$$0.5 < rm 2 x / rm 2 r < 3. \qquad ( 4 )$$

where rm2x is an x-direction partial curvature at a position where a light ray traveling in the z-direction from the center of the first rectangular region passes through the second reflection surface M2, rm2y is a y-direction partial curvature at a position where a light ray traveling in the z-direction from the center of the first rectangular region passes through the second reflection surface M2, the x-direction is a direction perpendicular to the meridional plane, the y-direction is a direction parallel to an intersection line between the meridional plane and the first rectangular region, and the z-direction is a direction perpendicular to the first rectangular region.

In the present embodiment, the astigmatism can be reduced and the size of the prism can be reduced by focusing on specific parameters (rm2x, rm2y) and satisfying Expression (4) expressing the relation between these parameters. If exceeding the upper limit value of Expression (4), the astigmatism will increase. If falling below the lower limit value of Expression (4), the size of the prism will increase.

The optical system according to the present embodiment may satisfy the following Expression (4a):

$$1. < rm 2 x / rm 2 y < 2. . \qquad ( 4 a )$$

The optical system according to the present embodiment may satisfy the following Expression (5):

$$0.3 < r mLx / rmLy < 1. \qquad ( 5 )$$

where, rmLx is an x-direction partial curvature at a position where a light ray traveling in the z-direction from the center of the first rectangular region passes through a reflection surface M3; M4 closest to the magnification side, rmLy is a y-direction partial curvature at a position where a light ray traveling in the z-direction from the center of the first rectangular region passes through a reflection surface M3; M4 closest to the magnification side, the x-direction is a direction perpendicular to the meridional plane, the y-direction is a direction parallel to an intersection line between the meridional plane and the first rectangular region, and the z-direction is a direction perpendicular to the first rectangular region.

In the present embodiment, the astigmatism can be reduced and the size of the prism can be reduced by focusing on specific parameters (rmLx, rmLy) and satisfying Expression (5) expressing the relation between these parameters. If exceeding the upper limit value of Expression (5), the size of the prism will increase. If falling below the lower limit value of Expression (5), the astigmatism will increase.

The optical system according to the present embodiment may satisfy the following Expression (5a):

$$0. 5 < r mLx / rmLy < 0.7 . \qquad ( 5 a )$$

The optical system according to the present embodiment may satisfy the following Expression (6):

$$- 45.0 < α t 2 < - 5. \qquad ( 6 )$$

where αt2 is an angle formed between a normal line NT1 of the first transmission surface T1 at a position where a light ray traveling in the z-direction from the center of the first rectangular region passes through the first transmission surface T1 and a normal line NT2 of the second transmission surface T2 at a position where a light ray passes through the second transmission surface T2, and the z-direction is a direction perpendicular to the first rectangular region.

In the present embodiment, it can be easy to manufacture the prism by focusing on the specific parameter (αt2) and satisfying Expression (6) expressing this relation. If exceeding the upper limit value of Expression (6), it becomes difficult to manufacture the prism, and the number of times of vapor deposition of the optical surface will increase. If falling below the lower limit value of Expression (6), the effective ranges of the optical surfaces will overlap with each other.

The optical system according to the present embodiment may satisfy the following Expression (6a):

$$- 40.0 < α t 2 < - 10. . \qquad ( 6 a )$$

The optical system according to the present embodiment may satisfy the following Expression (7):

$$- 55.0 < α m 1 < - 5. \qquad ( 7 )$$

where αm1 is an angle formed between a normal line NT1 of the first transmission surface T1 at a position where a light ray traveling in the z-direction from the center of the first rectangular region passes through the first transmission surface T1 and a normal line NM1 of the first reflection surface M1 at a position where the light ray passes through the first reflection surface M1, and the z-direction is a direction perpendicular to the first rectangular region.

In the present embodiment, it can be easy to manufacture the prism by focusing on the specific parameter (αm1) and satisfying Expression (7) expressing this relation. If exceeding the upper limit value of Expression (7), it becomes difficult to manufacture the prism, and the number of times of vapor deposition of the optical surface will increase. If falling below the lower limit value of Expression (7), the effective ranges of the optical surfaces will overlap with each other.

The optical system according to the present embodiment may satisfy the following Expression (7a):

$$- 50.0 < α m 1 < - 10. . \qquad ( 7 a )$$

The optical system according to the present embodiment may satisfy the following Expression (8):

$$- 5 5. < α m 2 < - 10. \qquad ( 8 )$$

where αm2 is an angle formed between a normal line NT1 of the first transmission surface T1 at a position where a light ray traveling in the z-direction from the center of the first rectangular region passes through the first transmission surface T1 and a normal line NM2 of the second reflection surface M2 at a position where the light ray passes through the second reflection surface M2, and the z-direction is a direction perpendicular to the first rectangular region.

In the present embodiment, it can be easy to manufacture the prism by focusing on the specific parameter (αm2) and satisfying Expression (8) expressing this relation. If exceeding the upper limit value of Expression (8), it becomes difficult to manufacture the prism, and the number of times of vapor deposition of the optical surface will increase. If falling below the lower limit value of Expression (8), the effective ranges of the optical surfaces will overlap with each other.

The optical system according to the present embodiment may satisfy the following Expression (8a):

$$- 55.0 < α m 2 < - 15. . \qquad ( 8 a )$$

The optical system according to the present embodiment may satisfy the following Expression (9):

$$- 50.0 < α m L < - 10. \qquad ( 9 )$$

where αmL is an angle formed between a normal line NT1 of the first transmission surface T1 at a position where a light ray traveling in the z-direction from the center of the first rectangular region passes through the first transmission surface T1 and a normal line NM3, NM4 of the reflection surfaces M3, M4 at a position where the light ray passes through the reflection surface M3, M4 closest to the magnification side, and the z-direction is a direction perpendicular to the first rectangular region.

In the present embodiment, it can be easy to manufacture the prism by focusing on the specific parameter (αmL) and satisfying Expression (9) expressing this relation. If exceeding the upper limit value of Expression (9), it becomes difficult to manufacture the prism, and the number of times of vapor deposition of the optical surface will increase. If falling below the lower limit value of Expression (9), the effective ranges of the optical surfaces will overlap with each other.

The optical system according to the present embodiment may satisfy the following Expression (9a):

$$- 45.0 < α m L < 5. . \qquad ( 9 a )$$

Hereinafter, numerical examples of the optical system according to Examples 1 to 3 are described. In each of the numerical examples, in the table, the unit of length is all “mm”, and the unit of angle of view is all “°” (degree). Further, in each of the numerical examples, a radius of curvature (ROC), a surface interval, a material are shown.

A free-form surface (FFS) shape of the prism optical surface is defined by the following formulas using a local orthogonal coordinate system (x, y, z) with the surface vertex thereof as origin point.

$$z = \frac{c {r}^{2}}{1 + \sqrt{1 - ( 1 + k ) {c}^{2} {r}^{2}}} + {\sum }_{j = 2}^{137} {C}_{j} {x}^{m} {y}^{n} \qquad [ Mathematical Formula 1 ]$$

$$j = \frac{{( m + n )}^{2} + m + 3 n}{2} + 1 \qquad [ Mathematical Formula 2 ]$$

where, Z is a sag height of a surface as measured in parallel to z-axis, r is a distance in the radial direction (=√(x²+y²)), c is a vertex curvature, k is a conic constant, and Cⱼ is a coefficient of a monomial X^{m}yⁿ.

### Numerical Example 1

Regarding the optical system of Numerical Example 1 (corresponding to Example 1), Table 1 shows lens data, Table 2 shows Y eccentricity amounts and a rotation amounts of the prism optical surface. Table 3 shows free-form surface shape data of the prism optical surface.

One prism optical surface may have plural surface numbers (For example, the first reflection surface M1 has four surface numbers S4 to S7), which indicates surface numbers used for coordinate transformation between global coordinates and local coordinates during numerical calculation. In addition, lateral aberration diagrams shown in FIGS. 2, 4 and 6 correspond to image height coordinates (x, y)=(0.000, 0.000), (0.000, 0.4075), (0.000, −0.4075), (0.3980, 0.000), (0.3980, 0.4075), (0.3980, −0.4075) of the first rectangular region, respectively. The same applies to other numerical examples.

TABLE 1

| LENS DATA | | | | | | | |
|---|---|---|---|---|---|---|---|
| | SURF. | SURF. | | SURFACE | | REF. | ECCENTRIC |
| | NO. | TYPE | ROC | INTERVAL | MATERIAL | SURF. | TYPE |
| | S1 | | | 0.5000 | | | |
| T1 | S2 | XY- | 2.9306 | 2.0781 | BK7_SCHOTT | | |
| | | POLY. | | | | | |
| | S3 | | | 0.0000 | BK7_SCHOTT | | NORMAL |
| | | | | | | | ECC. |
| M1 | S4 | XY- | −14.0414 | 0.0000 | BK7_SCHOTT | REF. | |
| | | POLY. | | | | | |
| | S5 | | | 0.0000 | BK7_SCHOTT | | NORMAL |
| | | | | | | | ECC. |
| | S6 | | | −2.3931 | BK7_SCHOTT | | |
| | S7 | | | 0.0000 | BK7_SCHOTT | | NORMAL |
| | | | | | | | ECC. |
| M2 | S8 | XY- | 1.7507 | 0.0000 | BK7_SCHOTT | REF. | |
| | | POLY. | | | | | |
| | S9 | | | 0.0000 | BK7_SCHOTT | | NORMAL |
| | | | | | | | ECC. |
| | S10 | | | 1.8469 | BK7_SCHOTT | | |
| | S11 | | | 0.0000 | BK7_SCHOTT | | NORMAL |
| | | | | | | | ECC. |
| M3 | S12 | XY- | 17.8700 | 0.0000 | BK7_SCHOTT | REF. | |
| | | POLY. | | | | | |
| | S13 | | | 0.0000 | BK7_SCHOTT | | NORMAL |
| | | | | | | | ECC. |
| | S14 | | | −2.7243 | BK7_SCHOTT | | |
| | S15 | | | 0.0000 | BK7_SCHOTT | | NORMAL |
| | | | | | | | ECC. |
| M4 | S16 | XY- | 7.8879 | 0.0000 | BK7_SCHOTT | REF. | |
| | | POLY. | | | | | |
| | S17 | | | 0.0000 | BK7_SCHOTT | | NORMAL |
| | | | | | | | ECC. |
| | S18 | | | 2.0329 | BK7_SCHOTT | | |
| T2 | S19 | XY- | −8.2385 | 0.2000 | | | |
| | | POLY. | | | | | |
| DOE | S20 | | | 0.5000 | BK7_SCHOTT | | |
| | S21 | | | 50.0000 | | | |

TABLE 2

| | ECCENTRIC | α ROTATION |
|---|---|---|
| α ROTATION | TYPE | AMOUNT |
| S3 | NORMAL | −13.830 |
| S5 | NORMAL | −13.830 |
| S7 | NORMAL | 13.830 |
| S9 | NORMAL | 13.830 |
| S11 | NORMAL | −27.446 |
| S13 | NORMAL | −27.446 |
| S15 | NORMAL | 27.446 |
| S17 | NORMAL | 27.446 |

TABLE 3

| FREE-FORM SURFACE | | | | |
|---|---|---|---|---|
| COEFFICIENTS OF XY-POLYNOMIAL | | | | |
| S2 | X\hat{ }0 | X\hat{ }2 | X\hat{ }4 | X\hat{ }6 |
| Y\hat{ }0 | | 3.67992E−01 | −1.53817E−02 | −7.16411E−02 |
| Y\hat{ }1 | −4.37867E−01 | −1.25804E−01 | −1.41588E−02 | 0.00000E+00 |
| Y\hat{ }2 | 1.42898E−01 | −6.71740E−02 | 2.62597E−01 | 0.00000E+00 |
| Y\hat{ }3 | 6.56514E−02 | −5.36532E−02 | 0.00000E+00 | 0.00000E+00 |
| Y\hat{ }4 | −2.16064E−01 | −3.75977E−01 | 0.00000E+00 | 0.00000E+00 |
| Y\hat{ }5 | 3.82435E−01 | 0.00000E+00 | 0.00000E+00 | 0.00000E+00 |
| Y\hat{ }6 | 1.77234E−02 | 0.00000E+00 | 0.00000E+00 | 0.00000E+00 |

| S4 | X\hat{ }0 | X\hat{ }2 | X\hat{ }4 | X\hat{ }6 |
|---|---|---|---|---|
| Y\hat{ }0 | | −9.36160E−03 | 9.89244E−03 | 1.92881E−03 |
| Y\hat{ }1 | 8.51505E−02 | −2.71450E−02 | −2.44039E−02 | 0.00000E+00 |
| Y\hat{ }2 | −9.30337E−02 | −2.26689E−02 | −2.80188E−03 | 0.00000E+00 |
| Y\hat{ }3 | 2.45541E−02 | 9.99791E−03 | 0.00000E+00 | 0.00000E+00 |
| Y\hat{ }4 | −9.88149E−03 | −7.43029E−03 | 0.00000E+00 | 0.00000E+00 |
| Y\hat{ }5 | 1.10262E−03 | 0.00000E+00 | 0.00000E+00 | 0.00000E+00 |
| Y\hat{ }6 | 9.99677E−04 | 0.00000E+00 | 0.00000E+00 | 0.00000E+00 |

| S8 | X\hat{ }0 | X\hat{ }2 | X\hat{ }4 | X\hat{ }6 | X\hat{ }8 |
|---|---|---|---|---|---|
| Y\hat{ }0 | | −1.1772.E−01 | −2.7335.E−02 | 1.8037.E−03 | −2.2529.E−03 |
| Y\hat{ }1 | −1.2715.E−01 | 9.1621.E−03 | 2.6213.E−02 | −9.9429.E−03 | 0.0000.E+00 |
| Y\hat{ }2 | −1.9713.E−01 | −1.7994.E−02 | −1.8311.E−02 | 0.0000.E+00 | 0.0000.E+00 |
| Y\hat{ }3 | 1.3566.E−01 | 4.2080.E−02 | −6.6706.E−03 | 0.0000.E+00 | 0.0000.E+00 |
| Y\hat{ }4 | −9.8765.E−02 | −5.2355.E−02 | 0.0000.E+00 | 0.0000.E+00 | 0.0000.E+00 |
| Y\hat{ }5 | 3.5811.E−02 | 2.5443.E−02 | 0.0000.E+00 | 0.0000.E+00 | 0.0000.E+00 |
| Y\hat{ }6 | −1.4942.E−02 | −1.0140.E−02 | 0.0000.E+00 | 0.0000.E+00 | 0.0000.E+00 |
| Y\hat{ }7 | 3.5435.E−03 | 0.0000.E+00 | 0.0000.E+00 | 0.0000.E+00 | 0.0000.E+00 |
| Y\hat{ }8 | −1.7542.E−03 | 0.0000.E+00 | 0.0000.E+00 | 0.0000.E+00 | 0.0000.E+00 |

| S12 | X\hat{ }0 | X\hat{ }2 | X\hat{ }4 | X\hat{ }6 | X\hat{ }8 |
|---|---|---|---|---|---|
| Y\hat{ }0 | | 1.03047E−01 | 7.11006E−02 | −6.55260E−01 | −8.26048E−01 |
| Y\hat{ }1 | 2.84854E−02 | −2.50095E−01 | 3.11784E−01 | 2.18395E+00 | 0.00000E+00 |
| Y\hat{ }2 | −6.26351E−02 | 1.55648E−01 | −1.15676E+00 | −1.89598E+00 | 0.00000E+00 |
| Y\hat{ }3 | −3.80469E−02 | −4.98341E−03 | 1.40360E+00 | 0.00000E+00 | 0.00000E+00 |
| Y\hat{ }4 | 6.54741E−02 | 7.68303E−03 | −4.50304E−01 | 0.00000E+00 | 0.00000E+00 |
| Y\hat{ }5 | −3.24161E−02 | −4.25986E−03 | 0.00000E+00 | 0.00000E+00 | 0.00000E+00 |
| Y\hat{ }6 | 8.42842E−03 | −1.84389E−03 | 0.00000E+00 | 0.00000E+00 | 0.00000E+00 |
| Y\hat{ }7 | −2.30956E−03 | 0.00000E+00 | 0.00000E+00 | 0.00000E+00 | 0.00000E+00 |
| Y\hat{ }8 | 1.33930E−03 | 0.00000E+00 | 0.00000E+00 | 0.00000E+00 | 0.00000E+00 |

| S16 | X\hat{ }0 | X\hat{ }2 | X\hat{ }4 | X\hat{ }6 |
|---|---|---|---|---|
| Y\hat{ }0 | | 1.96876E−02 | −1.94275E−04 | −8.81005E−05 |
| Y\hat{ }1 | −8.18893E−02 | −2.20129E−02 | −1.39451E−03 | 0.00000E+00 |
| Y\hat{ }2 | −1.36091E−02 | −3.79774E−04 | −6.10119E−04 | 0.00000E+00 |
| Y\hat{ }3 | −6.37630E−03 | −1.40554E−03 | 0.00000E+00 | 0.00000E+00 |
| Y\hat{ }4 | −1.20860E−04 | −1.34869E−04 | 0.00000E+00 | 0.00000E+00 |
| Y\hat{ }5 | −3.74531E−04 | 0.00000E+00 | 0.00000E+00 | 0.00000E+00 |
| Y\hat{ }6 | 8.83953E−05 | 0.00000E+00 | 0.00000E+00 | 0.00000E+00 |

| S19 | X\hat{ }0 | X\hat{ }2 | X\hat{ }4 | X\hat{ }6 |
|---|---|---|---|---|
| Y\hat{ }0 | | 2.00340E−02 | 5.73507E−04 | −3.74406E−04 |
| Y\hat{ }1 | 3.52111E−02 | −9.55544E−02 | −3.72420E−03 | 0.00000E+00 |
| Y\hat{ }2 | −3.31161E−03 | 1.49571E−02 | −2.21288E−03 | 0.00000E+00 |
| Y\hat{ }3 | −1.46954E−02 | −8.92989E−03 | 0.00000E+00 | 0.00000E+00 |
| Y\hat{ }4 | −4.51155E−04 | 3.30464E−04 | 0.00000E+00 | 0.00000E+00 |
| Y\hat{ }5 | −2.03669E−03 | 0.00000E+00 | 0.00000E+00 | 0.00000E+00 |
| Y\hat{ }6 | 3.52153E−04 | 0.00000E+00 | 0.00000E+00 | 0.00000E+00 |

### Numerical Example 2

Regarding the optical system of Numerical Example 2 (corresponding to Example 2), Table 4 shows lens data, Table 5 shows Y eccentricity amounts and α rotation amounts of the prism optical surface. Table 6 shows free-form surface shape data of the prism optical surface.

TABLE 4

| LENS DATA | | | | | | | |
|---|---|---|---|---|---|---|---|
| | SURF. | SURF. | | SURFACE | | REF. | ECCENTRIC |
| | NO. | TYPE | ROC | INTERVAL | MATERIAL | SURF. | TYPE |
| | S1 | | | 0.5000 | | | |
| T1 | S2 | XY- | 3.0426 | 2.1580 | BK7_SCHOTT | | |
| | | POLY. | | | | | |
| | S3 | | | 0.0000 | BK7_SCHOTT | | NORMAL |
| | | | | | | | ECC. |
| M1 | S4 | XY- | −7.6595 | 0.0000 | BK7_SCHOTT | REF. | |
| | | POLY. | | | | | |
| | S5 | | | 0.0000 | BK7_SCHOTT | | NORMAL |
| | | | | | | | ECC. |
| | S6 | | | −2.2705 | BK7_SCHOTT | | |
| | S7 | | | 0.0000 | BK7_SCHOTT | | NORMAL |
| | | | | | | | ECC. |
| M2 | S8 | XY- | 2.0214 | 0.0000 | BK7_SCHOTT | REF. | |
| | | POLY. | | | | | |
| | S9 | | | 0.0000 | BK7_SCHOTT | | NORMAL |
| | | | | | | | ECC. |
| | S10 | | | 1.9288 | BK7_SCHOTT | | |
| | S11 | | | 0.0000 | BK7_SCHOTT | | NORMAL |
| | | | | | | | ECC. |
| M3 | S12 | XY- | 43.6405 | 0.0000 | BK7_SCHOTT | REF. | |
| | | POLY. | | | | | |
| | S13 | | | 0.0000 | BK7_SCHOTT | | NORMAL |
| | | | | | | | ECC. |
| | S14 | | | −2.9320 | BK7_SCHOTT | | |
| | S15 | | | 0.0000 | BK7_SCHOTT | | NORMAL |
| | | | | | | | ECC. |
| M4 | S16 | XY- | 8.2258 | 0.0000 | BK7_SCHOTT | REF. | |
| | | POLY. | | | | | |
| | S17 | | | 0.0000 | BK7_SCHOTT | | NORMAL |
| | | | | | | | ECC. |
| | S18 | | | 1.9926 | BK7_SCHOTT | | |
| T2 | S19 | XY- | −14.9476 | 0.2000 | | | |
| | | POLY. | | | | | |
| DOE | S20 | | | 0.5000 | BK7_SCHOTT | | |
| | S21 | | | 50.0000 | | | |

TABLE 5

| | ECCENTRIC | α ROTATION |
|---|---|---|
| α ROTATION | TYPE | AMOUNT |
| S3 | NORMAL | −8.822 |
| S5 | NORMAL | −8.822 |
| S7 | NORMAL | 8.822 |
| S9 | NORMAL | 8.822 |
| S11 | NORMAL | −27.718 |
| S13 | NORMAL | −27.718 |
| S15 | NORMAL | 27.7178 |
| S17 | NORMAL | 27.7178 |

TABLE 6

| FREE-FORM SURFACE | | | | |
|---|---|---|---|---|
| COEFFICIENTS OF XY-POLYNOMIAL | | | | |
| S2 | X\hat{ }0 | X\hat{ }2 | X\hat{ }4 | X\hat{ }6 |
| Y\hat{ }0 | | −2.68313E−01 | −1.29717E−02 | 1.95020E−01 |
| Y\hat{ }1 | 0.00000E+00 | −1.32019E−01 | −6.15972E−02 | 0.00000E+00 |
| Y\hat{ }2 | 1.71790E−01 | −3.09750E−02 | 1.76083E−01 | 0.00000E+00 |
| Y\hat{ }3 | 1.71964E−01 | 5.34964E−03 | 0.00000E+00 | 0.00000E+00 |
| Y\hat{ }4 | −1.47498E−01 | −1.10600E−01 | 0.00000E+00 | 0.00000E+00 |
| Y\hat{ }5 | −3.97334E−02 | 0.00000E+00 | 0.00000E+00 | 0.00000E+00 |
| Y\hat{ }6 | 1.50492E−01 | 0.00000E+00 | 0.00000E+00 | 0.00000E+00 |

| S4 | X\hat{ }0 | X\hat{ }2 | X\hat{ }4 | X\hat{ }6 |
|---|---|---|---|---|
| Y\hat{ }0 | | −6.30796E−02 | −3.62064E−03 | 0.00000E+00 |
| Y\hat{ }1 | 1.12550E−01 | −2.91485E−02 | −2.95147E−03 | 0.00000E+00 |
| Y\hat{ }2 | −7.20631E−02 | −1.29011E−02 | −9.45014E−04 | 0.00000E+00 |
| Y\hat{ }3 | 1.66740E−02 | 8.90592E−03 | 0.00000E+00 | 0.00000E+00 |
| Y\hat{ }4 | 3.30343E−04 | 6.81207E−03 | 0.00000E+00 | 0.00000E+00 |
| Y\hat{ }5 | 2.15563E−03 | 0.00000E+00 | 0.00000E+00 | 0.00000E+00 |
| Y\hat{ }6 | 1.50452E−03 | 0.00000E+00 | 0.00000E+00 | 0.00000E+00 |

| S8 | X\hat{ }0 | X\hat{ }2 | X\hat{ }4 | X\hat{ }6 |
|---|---|---|---|---|
| Y\hat{ }0 | | −1.1450.E−01 | −3.8508.E−02 | −7.9867.E−04 |
| Y\hat{ }1 | −1.1901.E−01 | 7.4900.E−02 | 9.3656.E−02 | 0.0000.E+00 |
| Y\hat{ }2 | −2.3101.E−02 | 1.1243.E−01 | −6.0000.E−02 | 0.0000.E+00 |
| Y\hat{ }3 | 1.0421.E−01 | −7.5844.E−02 | 0.0000.E+00 | 0.0000.E+00 |
| Y\hat{ }4 | −1.3833.E−01 | 6.2278.E−03 | 0.0000.E+00 | 0.0000.E+00 |
| Y\hat{ }5 | 1.0273.E−01 | 0.0000.E+00 | 0.0000.E+00 | 0.0000.E+00 |
| Y\hat{ }6 | −3.7446.E−02 | 0.0000.E+00 | 0.0000.E+00 | 0.0000.E+00 |
| Y\hat{ }7 | 0.0000.E+00 | 0.0000.E+00 | 0.0000.E+00 | 0.0000.E+00 |
| Y\hat{ }8 | 0.0000.E+00 | 0.0000.E+00 | 0.0000.E+00 | 0.0000.E+00 |

| S12 | X\hat{ }0 | X\hat{ }2 | X\hat{ }4 | X\hat{ }6 |
|---|---|---|---|---|
| Y\hat{ }0 | | −2.79686E−02 | −4.84075E−03 | −8.76238E−04 |
| Y\hat{ }1 | −1.74315E−02 | −6.80175E−02 | 1.47884E−02 | 0.00000E+00 |
| Y\hat{ }2 | −2.90855E−02 | −4.59233E−02 | 9.24177E−03 | 0.00000E+00 |
| Y\hat{ }3 | −2.13906E−02 | 6.04579E−02 | 0.00000E+00 | 0.00000E+00 |
| Y\hat{ }4 | 4.41567E−02 | −2.22313E−02 | 0.00000E+00 | 0.00000E+00 |
| Y\hat{ }5 | −2.41915E−02 | 0.00000E+00 | 0.00000E+00 | 0.00000E+00 |
| Y\hat{ }6 | 4.89373E−03 | 0.00000E+00 | 0.00000E+00 | 0.00000E+00 |

| S16 | X\hat{ }0 | X\hat{ }2 | X\hat{ }4 | X\hat{ }6 |
|---|---|---|---|---|
| Y\hat{ }0 | | 1.49801E−02 | −1.22937E−03 | −6.64468E−05 |
| Y\hat{ }1 | −6.51847E−02 | −1.45692E−02 | −6.47857E−04 | 0.00000E+00 |
| Y\hat{ }2 | −1.29786E−02 | −2.42049E−03 | −9.59900E−05 | 0.00000E+00 |
| Y\hat{ }3 | 1.11493E−03 | −1.83611E−04 | 0.00000E+00 | 0.00000E+00 |
| Y\hat{ }4 | 1.31435E−03 | 1.50096E−04 | 0.00000E+00 | 0.00000E+00 |
| Y\hat{ }5 | −7.94330E−05 | 0.00000E+00 | 0.00000E+00 | 0.00000E+00 |
| Y\hat{ }6 | 9.46826E−06 | 0.00000E+00 | 0.00000E+00 | 0.00000E+00 |

| S19 | X\hat{ }0 | X\hat{ }2 | X\hat{ }4 | X\hat{ }6 |
|---|---|---|---|---|
| Y\hat{ }0 | | 7.27388E−02 | −8.46691E−03 | 8.19734E−05 |
| Y\hat{ }1 | 0.00000E+00 | −7.77277E−02 | 8.44295E−04 | 0.00000E+00 |
| Y\hat{ }2 | 2.99996E−03 | −4.04388E−03 | −6.21428E−04 | 0.00000E+00 |
| Y\hat{ }3 | 2.34161E−02 | −1.66257E−03 | 0.00000E+00 | 0.00000E+00 |
| Y\hat{ }4 | 1.08006E−02 | 2.73611E−04 | 0.00000E+00 | 0.00000E+00 |
| Y\hat{ }5 | 2.32060E−03 | 0.00000E+00 | 0.00000E+00 | 0.00000E+00 |
| Y\hat{ }6 | 4.62145E−04 | 0.00000E+00 | 0.00000E+00 | 0.00000E+00 |

### Numerical Example 3

Regarding the optical system of Numerical Example 3 (corresponding to Example 3), Table 7 shows lens data, Table 8 shows Y eccentricity amounts and α rotation amounts of the prism optical surface. Table 9 shows free-form surface shape data of the prism optical surface.

TABLE 7

| LENS DATA | | | | | | | |
|---|---|---|---|---|---|---|---|
| | SURF. | SURF. | | SURFACE | | REF. | ECCENTRIC |
| | NO. | TYPE | ROC | INTERVAL | MATERIAL | SURF. | TYPE |
| | S1 | | | 0.7236 | | | |
| T1 | S2 | XY- | 2.6745 | 3.8452 | BK7_SCHOTT | | |
| | | POLY. | | | | | |
| | S3 | | | 0.0000 | BK7_SCHOTT | | NORMAL |
| | | | | | | | ECC. |
| M1 | S4 | XY- | −10.5687 | 0.0000 | BK7_SCHOTT | REF. | |
| | | POLY. | | | | | |
| | S5 | | | 0.0000 | BK7_SCHOTT | | NORMAL |
| | | | | | | | ECC. |
| | S6 | | | −3.8595 | BK7_SCHOTT | | |
| | S7 | | | 0.0000 | BK7_SCHOTT | | NORMAL |
| | | | | | | | ECC. |
| M2 | S8 | XY- | 2.5466 | 0.0000 | BK7_SCHOTT | REF. | |
| | | POLY. | | | | | |
| | S9 | | | 0.0000 | BK7_SCHOTT | | NORMAL |
| | | | | | | | ECC. |
| | S10 | | | 4.0000 | BK7_SCHOTT | | |
| | S11 | | | 0.0000 | BK7_SCHOTT | | NORMAL |
| | | | | | | | ECC. |
| M3 | S12 | XY- | −4.4195 | 0.0000 | BK7_SCHOTT | REF. | |
| | | POLY. | | | | | |
| | S13 | | | 0.0000 | BK7_SCHOTT | | NORMAL |
| | | | | | | | ECC. |
| | S14 | | | −4.0000 | BK7_SCHOTT | | |
| T2 | S15 | XY- | −46.4035 | −0.2000 | | | |
| | | POLY. | | | | | |
| DOE | S16 | | | −0.5000 | BK7_SCHOTT | | |
| | S17 | | | −50.0000 | | | |

TABLE 8

| | ECCENTRIC | α ROTATION |
|---|---|---|
| α ROTATION | TYPE | AMOUNT |
| S3 | NORMAL | −11.978 |
| S5 | NORMAL | −11.978 |
| S7 | NORMAL | 11.978 |
| S9 | NORMAL | 11.978 |
| S11 | NORMAL | −18.981 |
| S13 | NORMAL | −18.981 |

TABLE 9

| FREE-FORM SURFACE | | | | |
|---|---|---|---|---|
| COEFFICIENTS OF XY-POLYNOMIAL | | | | |
| S2 | X\hat{ }0 | X\hat{ }2 | X\hat{ }4 | X\hat{ }6 |
| Y\hat{ }0 | | 1.73055E−02 | 2.90319E−02 | −6.58785E−02 |
| Y\hat{ }1 | −4.56843E−01 | −1.98893E−01 | −2.90628E−02 | 0.00000E+00 |
| Y\hat{ }2 | 1.32439E−01 | −9.61712E−02 | −4.62346E−02 | 0.00000E+00 |
| Y\hat{ }3 | 3.81152E−02 | 6.12542E−02 | 0.00000E+00 | 0.00000E+00 |
| Y\hat{ }4 | −1.34261E−01 | 1.82109E−02 | 0.00000E+00 | 0.00000E+00 |
| Y\hat{ }5 | 3.31572E−02 | 0.00000E+00 | 0.00000E+00 | 0.00000E+00 |
| Y\hat{ }6 | 1.70538E−01 | 0.00000E+00 | 0.00000E+00 | 0.00000E+00 |

| S4 | X\hat{ }0 | X\hat{ }2 | X\hat{ }4 | X\hat{ }6 |
|---|---|---|---|---|
| Y\hat{ }0 | | −1.90340E−02 | −1.03798E−03 | −2.00362E−04 |
| Y\hat{ }1 | 8.62333E−02 | −1.81758E−03 | 1.95755E−03 | 0.00000E+00 |
| Y\hat{ }2 | −3.93647E−02 | 5.45114E−04 | −9.31293E−04 | 0.00000E+00 |
| Y\hat{ }3 | −2.81255E−03 | −2.93863E−03 | 0.00000E+00 | 0.00000E+00 |
| Y\hat{ }4 | 6.07994E−03 | 1.83847E−03 | 0.00000E+00 | 0.00000E+00 |
| Y\hat{ }5 | −3.02995E−03 | 0.00000E+00 | 0.00000E+00 | 0.00000E+00 |
| Y\hat{ }6 | 8.15721E−04 | 0.00000E+00 | 0.00000E+00 | 0.00000E+00 |

| S8 | X\hat{ }0 | X\hat{ }2 | X\hat{ }4 | X\hat{ }6 | X\hat{ }8 |
|---|---|---|---|---|---|
| Y\hat{ }0 | | −1.0182.E−01 | 9.9344.E−04 | −7.8712.E−04 | −4.7496.E−05 |
| Y\hat{ }1 | −1.3704.E−02 | −4.1521.E−02 | −2.2602.E−02 | −4.4454.E−04 | 0.0000.E+00 |
| Y\hat{ }2 | −2.5761.E−01 | 5.6002.E−02 | 2.5174.E−02 | 0.0000.E+00 | 0.0000.E+00 |
| Y\hat{ }3 | 1.4295.E−01 | −6.3055.E−04 | −9.8814.E−03 | 0.0000.E+00 | 0.0000.E+00 |
| Y\hat{ }4 | −8.2398.E−02 | −6.3886.E−02 | 0.0000.E+00 | 0.0000.E+00 | 0.0000.E+00 |
| Y\hat{ }5 | 3.8701.E−02 | 5.0966.E−02 | 0.0000.E+00 | 0.0000.E+00 | 0.0000.E+00 |
| Y\hat{ }6 | −1.9928.E−02 | −1.2958.E−02 | 0.0000.E+00 | 0.0000.E+00 | 0.0000.E+00 |
| Y\hat{ }7 | 7.1402.E−03 | 0.0000.E+00 | 0.0000.E+00 | 0.0000.E+00 | 0.0000.E+00 |
| Y\hat{ }8 | −1.3079.E−03 | 0.0000.E+00 | 0.0000.E+00 | 0.0000.E+00 | 0.0000.E+00 |
| S12 | X\hat{ }0 | X\hat{ }2 | X\hat{ }4 | X\hat{ }6 | X\hat{ }8 |
| Y\hat{ }0 | | 4.27739E−02 | 4.44647E−03 | 7.27441E−04 | −1.98081E−04 |
| Y\hat{ }1 | 1.02810E−01 | 2.16909E−02 | 4.72926E−03 | −6.91298E−04 | 0.00000E+00 |
| Y\hat{ }2 | 5.41977E−02 | 5.48683E−04 | 5.04284E−03 | −2.06410E−03 | 0.00000E+00 |
| Y\hat{ }3 | 1.56136E−02 | 1.34934E−02 | −1.08147E−03 | 0.00000E+00 | 0.00000E+00 |
| Y\hat{ }4 | 5.79962E−03 | −8.52061E−03 | 1.98026E−03 | 0.00000E+00 | 0.00000E+00 |
| Y\hat{ }5 | −1.37678E−02 | 6.18000E−03 | 0.00000E+00 | 0.00000E+00 | 0.00000E+00 |
| Y\hat{ }6 | 1.96517E−02 | −1.57276E−03 | 0.00000E+00 | 0.00000E+00 | 0.00000E+00 |
| Y\hat{ }7 | −1.32407E−02 | 0.00000E+00 | 0.00000E+00 | 0.00000E+00 | 0.00000E+00 |
| Y\hat{ }8 | 3.56995E−03 | 0.00000E+00 | 0.00000E+00 | 0.00000E+00 | 0.00000E+00 |

| S15 | X\hat{ }0 | X\hat{ }2 | X\hat{ }4 | X\hat{ }6 |
|---|---|---|---|---|
| Y\hat{ }0 | | 2.00771E−01 | 2.18200E−03 | 8.96745E−05 |
| Y\hat{ }1 | −2.03045E−01 | 2.31489E−02 | 2.73693E−03 | 0.00000E+00 |
| Y\hat{ }2 | 1.59700E−01 | −1.08323E−03 | 1.53577E−04 | 0.00000E+00 |
| Y\hat{ }3 | 4.93124E−03 | 4.22569E−03 | 0.00000E+00 | 0.00000E+00 |
| Y\hat{ }4 | 1.06941E−03 | −7.84037E−04 | 0.00000E+00 | 0.00000E+00 |
| Y\hat{ }5 | 6.37643E−04 | 3.52153E−04 | 0.00000E+00 | 0.00000E+00 |
| Y\hat{ }6 | 9.22447E−05 | 0.00000E+00 | 0.00000E+00 | 0.00000E+00 |

Table 10 below shows the corresponding values of the respective conditional expressions (1) to (9) in the respective Numerical Examples 1 to 3.

Table 10

| | EXAMPLE 1 | EXAMPLE 2 | EXAMPLE 3 |
|---|---|---|---|
| CONDITION (1) | 3.56 | 3.33 | 2.39 |
| CONDITION (2) | 3.34 | 0.24 | 0.66 |
| CONDITION (3) | 1.97 | 1.05 | 1.23 |
| CONDITION (4) | 1.21 | 1.38 | 1.30 |
| CONDITION (5) | 0.59 | 0.60 | 0.59 |
| CONDITION (6) | −37.91 | −15.24 | −35.35 |
| CONDITION (7) | −46.01 | −18.47 | −43.73 |
| CONDITION (8) | −46.74 | −22.89 | −46.73 |
| CONDITION (9) | −25.42 | −0.84 | −38.26 |

Table 11 below shows the numerical values of the variables included in the respective conditional expressions (1) to (9) in the respective Numerical Examples 1 to 3.

TABLE 11

| | EXAM- | EXAM- | EXAM- |
|---|---|---|---|
| | PLE 1 | PLE 2 | PLE 3 |
| PUPIL DIAMETER ED | 1.24 | 1.52 | 0.79 |
| PUPIL POSITION ET | 4.41 | 5.08 | −1.89 |
| rt1x | 0.93 | −4.81 | 2.45 |
| rt1y | 2.07 | 1.49 | 2.08 |
| rt2x | −11.41 | 9.14 | 2.52 |
| rt2y | −7.65 | −11.88 | 3.26 |
| rm1x | −8.92 | −3.90 | −7.38 |
| rm1y | −4.53 | −3.71 | −5.99 |
| rm2x | 2.50 | 2.45 | 4.93 |
| rm2y | 2.06 | 1.77 | 3.80 |
| rmlx | 6.11 | 6.36 | −8.51 |
| rmly | 10.36 | 10.64 | −14.42 |

### Third Embodiment

Hereinafter, a third embodiment of the present disclosure is described with reference to FIG. 9. FIG. 9 is a block diagram showing an example of the image projection apparatus according to the present disclosure. The image projection apparatus 100 includes such an optical system 1 as disclosed in Second Embodiment, an image forming element 101, a light source 102, a control unit 110, and others. In a case of image projection apparatus, the diffractive optical element DOE may be omitted.

The image forming element 101 is constituted of, for example, liquid crystal or DMD, for generating an image to be projected through the optical system 1 onto a screen SR. The light source 102 is constituted of, for example, light emitting diode (LED) or laser, for supplying light to the image forming element 101. The control unit 110 is constituted of, for example, central processing unit (CPU) or micro-processing unit (MPU), for controlling the entire apparatus and respective components. The optical system 1 may be configured as either an interchangeable lens that can be detachably attached to the image projection apparatus 100 or a built-in lens that is integrated in the image projection apparatus 100.

The image projection apparatus 100 including the optical system according to Second Embodiment can realize projection with a shorter focal length and a larger-sized screen.

### Fourth Embodiment

Hereinafter, a fourth embodiment of the present disclosure is described with reference to FIG. 10. FIG. 10 is a block diagram showing an example of the imaging apparatus according to the present disclosure. The imaging apparatus 200 includes such an optical system 1 as disclosed in Second Embodiment, an imaging element 201, a control unit 210, and others. In a case of imaging apparatus, the diffractive optical element DOE may be omitted.

The imaging element 201 is constituted of, for example, charge coupled device (CCD) image sensor or complementary metal oxide semiconductor (CMOS) image sensor, for receiving an optical image of an object OBJ formed by the optical system 1 to convert the image into an electrical image signal. The control unit 110 is constituted of, for example, CPU or MPU, for controlling the entire apparatus and respective components. The optical system 1 may be configured as either an interchangeable lens that can be detachably attached to the imaging apparatus 200 or a built-in lens that is integrated in the imaging apparatus 200.

The imaging apparatus 200 including the optical system according to Second Embodiment can realize imaging with a shorter focal length and a larger-sized screen.

As described above, the embodiments have been described to disclose the technology in the present disclosure. To that end, the accompanying drawings and detailed description are provided.

Therefore, among the components described in the accompanying drawings and the detailed description, not only the components that are essential for solving the problem, but also the components that are not essential for solving the problem may also be included in order to exemplify the above-described technology. Therefore, it should not be directly appreciated that the above non-essential components are essential based on the fact that the non-essential components are described in the accompanying drawings and the detailed description.

Further, the above-described embodiments have been described to exemplify the technology in the present disclosure. Thus, various modification, substitution, addition, omission and so on can be made within the scope of the claims or equivalents thereof.

### INDUSTRIAL APPLICABILITY

The present disclosure can be applied to image projection apparatuses such as projectors and head-up displays, and imaging apparatuses such as digital still cameras, digital video cameras, surveillance cameras in surveillance systems, web cameras, and onboard cameras. In particular, the present disclosure can be applied to optical systems that require a high image quality, such as projectors, digital still camera systems, and digital video camera systems. In addition, the present disclosure can be applied to optical systems for multi-beam projection apparatuses.

1. An optical system having a reduction conjugate point on a reduction side and a magnification conjugate point on a magnification side that are optically conjugate with each other, and includes
a prism including a first transmission surface located on the reduction side, a second transmission surface located on the magnification side, and at least three reflection surfaces located on an optical path between the first transmission surface and the second transmission surface,
wherein the prism has a meridional plane through which a light ray reflected by the at least three reflection surfaces pass,
wherein a first rectangular region at the reduction conjugate point and a second rectangular region at the magnification conjugate point have an optically conjugate image forming relation, and
wherein in the meridional plane, two light rays traveling in a direction perpendicular to the first rectangular region from two points on the first rectangular region intersect at two intersection positions after passing through the first transmission surface and then reflected by the at least three reflection surfaces and before passing through the second transmission surface, and the number of reflection of the two light rays intersecting at each intersection position before reaching the respective intersection positions is the same.

2. The optical system according to claim 1, wherein an intermediate imaging position having a conjugate relation with each of the reduction conjugate point and the magnification conjugate point may be positioned inside the prism.

3. The optical system according to claim 1, wherein the prism includes at least the first transmission surface, a first reflection surface, a second reflection surface, and the second transmission surface in this order from the reduction side to the magnification side, and one of the two intersection positions may be positioned between the first reflection surface and the second reflection surface.

4. The optical system according to claim 1, satisfying the following Expression (1):
$$1. < \vert ET / ED \vert < 5. \qquad ( 1 )$$
where ET is a distance from the second transmission surface to a pupil position on the magnification side, and ED is a pupil diameter on the magnification side.

5. The optical system according to claim 3, satisfying the following Expression (2):
$$- 10 \text{.0} < ( rt 1 y \times rt 2 x ) / ( rt 1 x \times rt 2 y ) < 10. \qquad ( 2 )$$
where rt1x is an x-direction partial curvature at a position where a light ray traveling in the z-direction from the center of the first rectangular region passes through the first transmission surface, rt1y is a y-direction partial curvature at a position where a light ray traveling in the z-direction from the center of the first rectangular region passes through the first transmission surface, rt2x is an x-direction partial curvature at a position where a light ray traveling in the z-direction from the center of the first rectangular region passes through the second transmission surface, rt2y is a y-direction partial curvature at a position where a light ray traveling in the z-direction from the center of the first rectangular region passes through the second transmission surface, the x-direction is a direction perpendicular to the meridional plane, the y-direction is a direction parallel to an intersection line between the meridional plane and the first rectangular region, and the z-direction is a direction perpendicular to the first rectangular region.

6. The optical system according to claim 3, satisfying the following Expression (3):
$$0.5 < rm 1 x / rm 1 y < 4. \qquad ( 3 )$$
where rm1x is an x-direction partial curvature at a position where a light ray traveling in the z-direction from the center of the first rectangular region passes through the first reflection surface, rm1y is a y-direction partial curvature at a position where a light ray traveling in the z-direction from the center of the first rectangular region passes through the first reflection surface, the x-direction is a direction perpendicular to the meridional plane, the y-direction is a direction parallel to an intersection line between the meridional plane and the first rectangular region, and the z-direction is a direction perpendicular to the first rectangular region.

7. The optical system according to claim 3, satisfying the following Expression (4):
$$0. 5 < rm 2 x / rm 2 y < 3. \qquad ( 4 )$$
where rm2x is an x-direction partial curvature at a position where a light ray traveling in the z-direction from the center of the first rectangular region passes through the second reflection surface, rm2y is a y-direction partial curvature at a position where a light ray traveling in the z-direction from the center of the first rectangular region passes through the second reflection surface, the x-direction is a direction perpendicular to the meridional plane, the y-direction is a direction parallel to an intersection line between the meridional plane and the first rectangular region, and the z-direction is a direction perpendicular to the first rectangular region.

8. The optical system according to claim 3, satisfying the following Expression (5):
$$0.3 < rmLx / rmLy < 1. \qquad ( 5 )$$
where, rmLx is an x-direction partial curvature at a position where a light ray traveling in the z-direction from the center of the first rectangular region passes through a reflection surface closest to the magnification side, rmLy is a y-direction partial curvature at a position where a light ray traveling in the z-direction from the center of the first rectangular region passes through a reflection surface closest to the magnification side, the x-direction is a direction perpendicular to the meridional plane, the y-direction is a direction parallel to an intersection line between the meridional plane and the first rectangular region, and the z-direction is a direction perpendicular to the first rectangular region.

9. The optical system according to claim 3, satisfying the following Expression (6):
$$- 45.0 < α t 2 < - 5. \qquad ( 6 )$$
where αt2 is an angle formed between a normal line of the first transmission surface at a position where a light ray traveling in the z-direction from the center of the first rectangular region passes through the first transmission surface and a normal line of the second transmission surface at a position where a light ray passes through the second transmission surface, and the z-direction is a direction perpendicular to the first rectangular region.

10. The optical system according to claim 3, satisfying the following Expression (7):
$$- 55.0 < α m 1 < - 5. \qquad ( 7 )$$
where αm1 is an angle formed between a normal line of the first transmission surface at a position where a light ray traveling in the z-direction from the center of the first rectangular region passes through the first transmission surface and a normal line NM1 of the first reflection surface at a position where the light ray passes through the first reflection surface, and the z-direction is a direction perpendicular to the first rectangular region.

11. The optical system according to claim 3, satisfying the following Expression (8):
$$- 55.0 < α m 2 < - 10. \qquad ( 8 )$$
where αm2 is an angle formed between a normal line of the first transmission surface at a position where a light ray traveling in the z-direction from the center of the first rectangular region passes through the first transmission surface and a normal line of the second reflection surface at a position where the light ray passes through the second reflection surface, and the z-direction is a direction perpendicular to the first rectangular region.

12. The optical system according to claim 3, satisfying the following Expression (9):
$$- 50.0 < α m L < - 10. \qquad ( 9 )$$
where αmL is an angle formed between a normal line of the first transmission surface at a position where a light ray traveling in the z-direction from the center of the first rectangular region passes through the first transmission surface and a normal line of the reflection surfaces at a position where the light ray passes through the reflection surface closest to the magnification side, and the z-direction is a direction perpendicular to the first rectangular region.

13. A multi-beam projection optical system comprising:
the optical system according to claim 1; and
a diffractive optical element that spatially branches the light ray emitted from the prism.

14. A multi-beam projection apparatus comprising:
the multi-beam projection optical system according to claim 13; and
a light source that generates one or more light beams toward the multi-beam projection optical system.

15. An image projection apparatus comprising:
the optical system according to claim 1; and
an image forming element that generates an image to be projected through the optical system onto a screen.

16. An imaging apparatus comprising:
the optical system according to claim 1; and
an imaging element that receives an optical image formed by the optical system to convert the optical image into an electrical image signal.
